(19) United States
(12) Patent Application Publication
(10) Pub. No.: US 2024/0240972 A1
(43) Pub. Date: Jul. 18, 2024

(54) COMMUNICATION IN MULTI-CARRIER SYSTEMS, LINEAR MOTORS, TRANSPORT DEVICES

(71) Applicant: Schneider Electric Industries SAS, Rueil-Malmaison (FR)

(72) Inventors: Martin Stollberger, Uettingen (DE); Johannes Kempf, Großheubach (DE); Guillaume Geoffroy, Ettenheim (DE)

(73) Assignee: Schneider Electric Industries SAS, Rueil-Malmaison (FR)

(21) Appl. No.: 18/411,588

(22) Filed: Jan. 12, 2024

(30) Foreign Application Priority Data
Jan. 18, 2023 (EP) 23152294.7

(51) Int. Cl. G01D 5/245; H01F 7/02; H01F 7/20

(52) U.S. Cl. CPC G01D 5/2451; H01F 7/02; H01F 7/20

(57) ABSTRACT

A position encoder transmitter (100) has a first magnet device (16, 101), preferably a permanent magnet, a settable second magnet device (102) that is fastened to or near the first magnet device and that can be an electromagnet, and a setting device (103-106) for the second magnet device that is adapted to cause or perform the setting of the second magnet device in accordance with information to be transmitted.

The invention relates to the communication in multi-carrier systems, linear motors and transport devices, in particular the communication in components of multi-carrier systems, linear motors and transport devices that are movable relative to one another.

One application example for the field of the invention is the multi-carrier system schematically shown in FIG. 16. It can represent a linear motor comprising a stator, which extends in the transport direction and is optionally closed to form a loop, and a plurality of carriers extending along the stator. More generally, it can also be a rail-bound transport system 11 comprising a rail 17, preferably closed to form a loop, and a plurality of movable carriages 15 thereat or thereon. Carriers or carriages can approach and leave the schematically shown work stations 18. The work stations 18 can e.g. be processing stations. They can have robotics and/or machine tools and/or sensors or measurement devices and can work autonomously, but can also be network-connected. The multi-carrier system can also be network-connected.

In FIG. 16, the carriages 15 are drawn equidistantly. This may or may not be the case. The carriages 15 can be controllable and moveable individually and independently of one another. They can each be individually movably guided along the rail 17, both in position and in the direction of movement and speed. The transport system according to FIG. 16 works on the principle of a linear motor in which the rail 17 can be or can be regarded as a stator and the carriages 15 can be or can be regarded as carriers. What is not shown in FIG. 16 is a present control that performs complex control tasks, for instance controlling the individual carriages (speed, position, direction of movement), collision avoidance, etc. For the drive, the control can selectively energize electromagnets or coils of the linear motor, for instance by means of PWM (“pulse width modulation”). DC voltage can be switched on and off here. Or a four-quadrant controller can be used that can also reverse the energization of an electromagnet.

The control can take place in accordance with present and likewise not shown sensors, in particular e.g. position sensors, that preferably record the positions of the carriers or carriages, and possibly also their speed, in real time and make these variables accessible to a control.

It should be pointed out right here that the movements of the stator and the carrier take place relative to one another and stator and carrier are a priori interchangeable terms in this respect, depending on whose reference system is regarded as static. The same applies analogously to rails and carriages.

FIG. 17 shows an example of how the electromagnetic design can be. 15, 502 above symbolizes the carrier 502 or the carriage 15 that is drawn floating above the rail 13, 17 or the stator 501. However, mechanical connections in the form of wheels or other guide mechanisms are usually present to guide the stator and the carrier or the rail and the carriage in a defined manner relative to one another. Arrow 19 symbolizes the direction of movement of the carriage 15 relative to the rail 13, 17. It is left-right in FIG. 17 and can go in both directions. The carriage 15 is shown bounded since it will usually be a relatively small unit, while the rail 13, 17, 501 is drawn broken off since it can extend to a greater or lesser extent, and theoretically expanded as far as desired, in the direction of movement.

The carrier 502 can have two magnets 171, 173 that are spaced apart from one another by an increment S502 in the direction of movement of the arrow 19. The magnets can be oriented antiparallel; the orientation direction can be perpendicular to the boundary surface between the stator 501 and the carrier 502. An iron core 172 can lie over the inwardly disposed ends of the permanent magnets 171, 173 and can create a soft magnetic path between them.

In the stator 501, a plurality of or many electromagnets 12a, 12b are provided in a row along the direction of movement 19 and each have an iron core 175, 177 and an electromagnet winding or a coil 174, 178 thereon. Only two of them are drawn in more detail. The others are indicated by dashed lines and can be designed in the same way. For the conventional drive, two or more electromagnets spaced apart in the direction of movement can be energized temporarily, while the other electromagnets remain de-energized. With the movement of the carrier 502 or carriage 15, the respective coils currently to be energized accordingly also change. The control can possibly have a selection device for this purpose.

The increment S501 between energized electromagnets can be different from the increment S502 between the permanent magnets of the carrier. It can in particular be slightly larger or slightly smaller, e.g. less than +/−20 or +/−10 or +/−5% of S502. An energization in the same direction of two coils is indicated in FIG. 17, wherein it is again noted that more than two coils can be energized. This then results in a mixture of attractive and repulsive magnetic forces that lead to a defined movement of the carrier. The energization of the electromagnets can be pulse-width modulated. The pulse frequency will usually be significantly higher than the frequency at which the carrier passes electromagnets 12 of the stator so that many PWM pulses are fed in during the passage of an electromagnet.

It is desirable to have a communication possibility between the stator and the carrier or the rail and the carriage. The communication is desirable in both directions, i.e. both from the carriage or carrier to the rail or stator and also vice versa, e.g. to be able to initially read out information from the carrier 502 at work stations 18 and finally also to be able to write it in there.

The transport system of FIG. 16 can, for example, move sequentially along work stations 18 of a production line. The carriages 15, for example, carry more or less widely manufactured products. The carriage itself can then e.g. bear individual information about the respective carried product that can, for example, be written in at one work station and read out at a next station. Some of these work stations are symbolized by reference number 18 in FIG. 16.

It is known to provide a position detection using inductive and/or other magnetic effects. The carriages 15 can fixedly take along a permanent magnet 16 that, together with the carriage 15, travels past corresponding inductive pick-ups that are attached along the rail 17. In this way, the movement of a carriage can be tracked. However, it cannot be communicated. It is also known to provide separate communication systems between the carriage 15 and the rail 17 that transport information wirelessly in the desired direction. The disadvantage of these known systems is that they have to be installed separately in a complex manner.

It is the object of the invention to provide devices and methods for the communication between components of a multi-carrier system, of a linear motor or of a transport system that are movable relative to one another, that are comparatively simple and require no or as few hardware components to be additionally provided as possible or can use the hardware that is at least partially present anyway.

This object is satisfied by the features of the independent claims.

### A. COMMUNICATION FROM THE CARRIER OR CARRIAGE TO THE RAIL OR STATOR

A known position encoder transmitter is preferably further developed or extended by some few components. It is provided with a first magnet device, preferably a permanent magnet, a settable second magnet device that is fastened to or near the first magnet device and that can be an electromagnet, and a setting device for the second magnet device that is adapted to set the second magnet device in accordance with information to be transmitted. It can have a preferably sampling current control for the second magnet device or the electromagnet.

The first magnet device can be the magnet of a position encoder transmitter that serves for the position determination or presence recognition when the first magnet device travels over a corresponding receiver or pick-up. The second magnet device can generate a magnetic field that is superimposed on or replaces the magnetic field of the first magnet device and that is modulated in accordance with the information to be transmitted.

The electromagnet and the current control can be adapted to generate a magnetic field of a field strength whose amplitude at an associated magnetic field pick-up is at least 1% or 5% or 10% or 20% of the amplitude of the field strength of the first magnet device at the associated pick-up and/or whose amplitude is at most 5 times or 2 times or 1 times the amplitude of the field strength of the first magnet device.

If the magnetic fields are suitably set at the transmitter side, e.g. as described, they can be received at the receiver side or pick-up side and their two meanings can be distinguished. The one meaning is the conventional presence and position recognition that can be effected by a constant magnetic field or a DC component of a changing magnetic field. The second meaning is the information transmission from the carriage or carrier to the rail or stator. The transmitted information is modulated in the changing component of the magnetic field picked up at the receiver side.

The first magnet device can be a permanent magnet and the second magnet device can be an electromagnet whose winding is wound around the permanent magnet or lies near or in the vicinity of the first magnet device, e.g. contacts it.

The position encoder transmitter can have an energy supply inductively absorbing energy. It can be a “power harvesting” energy supply that, among other things, picks up stray fields of the electric drive, converts them into electrical variables, stores the energy thus absorbed and uses it for the energy supply of the devices of the position encoder transmitter.

The position encoder transmitter can generally have a more or less complex circuit. The circuit can operate digitally and can accordingly have one or more analog/digital converters at the input side and one or more digital/analog converters at the output side. It can be a small processor or a small computer comprising typical components such as a CPU, memory, BUS, etc. The information to be transmitted can be generated at the position encoder side or read from a memory. A coding device then correspondingly generates control signals for the setting device of the second magnet device.

The position encoder transmitter can have a carrier to which the first magnet device and the second magnet device are fastened. The carrier can in turn be fastened or fastenable to a linear motor carrier or a carriage of a transport system. Components anyway present at the linear motor carrier or the carriage, such as an energy supply, computing power or similar, can then also be used.

The first magnet device can also be configured as an electromagnet and can be the same electromagnet as that of the second magnet device. The design can then be such that the control is different when only the position is indicated than if information is also to be transmitted. The disadvantage of this embodiment is that if there are power supply problems in the carrier or carriage, possibly no indication of the position is possible since the first magnet device then cannot be energized.

A control of the position encoder transmitter can determine a starting point in time and/or an end point in time for the information transmission and/or an amount of data to be transmitted. Successful data transmission requires a suitable pick-up to be disposed opposite the transmitting movable carriage or carrier, which, however, does not always have to be the case due to the movability. However, the relative position of the carriage/carrier relative to a suitable pick-up can generally be known in the system and the starting point in time can be determined in accordance with this known relative position and/or possibly further parameters such as a recordable field strength and/or a signal-to-noise ratio and/or speed or similar.

The information transmission is therefore preferably adapted to the changing reception possibility, which can comprise defining a starting point in time, i.e. the point in time at which the carriage or carrier enters the range of a pick-up, and also defining an amount of data or an end point in time of the data transmission. However, the amount of data can, for example, also be fixed and can be determined based on system parameters such as the maximum speed, data capacity of the channel, etc. The end of transmission then implicitly results from the start of transmission plus the transmission duration of the set amount of data. A data transmission can be repeated multiple times to be able to recognize errors, if necessary, and eliminate them where possible.

The setting device for the electromagnet of the second magnet device can implement a suitable modulation method to control the energization of the second magnet device in accordance with the information to be transmitted. The information to be transmitted is preferably digital information to be transmitted serially that is read from a memory at a transmission point in time. A modulation method here can be the amplitude modulation of a coil current, in particular an alternating current, and correspondingly of a generated magnetic field, in particular an alternating magnetic field. The amplitude itself can bear the digital information, for example one amplitude can mean a digital “1”, another amplitude a digital “0”. Or the change in amplitude can bear the digital information. A Manchester coding can, for example, be used.

A linear motor carrier can be provided with the above-described position encoder transmitter. A carriage of a transport system can also be provided with the position encoder transmitter as described. The transport system can be rail-supported, but does not have to be. The carriage can move autonomously and as such can head for stations in which a position encoder receiver complementary to the position encoder transmitter is present.

A position encoder receiver has a magnetically or inductively operating pick-up that is adapted to convert an external magnetic field, preferably of a position encoder transmitter as described, into electrical signals. The pick-up can be a HALL, AMR, TMR or GMR pick-up. It can preferably be a two-dimensionally measuring Hall pick-up or have such a one. The receiver also has an evaluation device that is adapted to convert the electrical signals and to extract, from them, a first piece of position information and a transmitted second piece of information, preferably as digitally processable information.

The position encoder receiver is formed in a complementary manner to the transmitter described. On the one hand, it serves for the conventional presence or position detection by recording and, if necessary, evaluating the magnetic field generated by the first magnet device. On the other hand, it serves to record information by recording the magnetic field that is generated by the second magnet device and that is preferably a superimposed alternating magnetic field by converting this alternating magnetic field into the electrical, shaping it and evaluating it, in particular demodulating it.

The evaluation device can be adapted to recognize signals from an external permanent magnetic field and, accordingly, to generate a first piece of digitally processable information as position information, and to recognize signals from an external alternating magnetic field and, accordingly, to generate a second piece of digitally processable information in a manner corresponding to a second piece of information transmitted with the alternating magnetic field.

It should be noted in this connection that the position information is not absolute position information. Rather, it is the information that the component carrying the position encoder transmitter (carrier, carriage) is present at the location of the pick-up. Together with other information available in the system, the position in a virtual model of the system can be determined therefrom. However, within the detection range of a pick-up, a certain spatial resolution of the position of the carriage/carrier relative to the pick-up can be possible, for instance based on detected magnetic field strengths and/or magnetic field directions. This is possible, for example, with Hall pick-ups that detect Hall voltages in mutually different and preferably mutually orthogonal directions.

The magnetic field recorded by the position encoder receiver, in particular an alternating magnetic field, is converted into a corresponding electrical signal. It can be further processed electrically, either in analog or digital form, to extract the information possibly included in the recorded magnetic field. A process can take place here that ultimately takes place backwards compared to the transmitter-side process. Extracted and digitally available information can then be saved or output to external via an interface.

The advantage of this design of the position encoder receiver is that, depending on the design, no further hardware components are required than with known position encoder receivers. Further measures are only necessary at the control side. If this takes place in a computer-assisted manner, it can be a solution that can be implemented with software so that no changes need to be made to the hardware at the receiver side. The additional second magnet device, i.e. usually an electromagnet, and devices for its controlled energization are to be provided at the transmitter side.

A linear motor stator of a rail-supported transport system has a position encoder receiver as described above. A rail segment of a rail-supported transport system also has a position encoder receiver as described above. A position encoder system has at least one position encoder transmitter as described above and at least one position encoder receiver as described above.

A linear motor has a linear motor stator as described above and a linear motor carrier as described above. A transport system has at least one carriage as described above and at least one rail segment as described above.

### B. COMMUNICATION FROM THE STATOR OR FROM THE RAIL TO THE CARRIER OR CARRIAGE

Features of the communication from the carrier or carriage to the rail or stator have been described above. They can be combined with the following features of the communication from the stator or the rail to the carrier or carriage, but can also be used on their own.

A control device for controlling the feeding of electrical power to electromagnets of an electric drive, in particular a linear motor stator, has a control comprising a first control component that is adapted to cause, in accordance with a drive desired value, the generation of first PWM control signals for controlling the energization of the electromagnets, and a second control component that is adapted to cause, in accordance with information to be transmitted, the generation of the first PWM control signals to be converted into a generation of other second PWM control signals.

To transmit information from the stator or the rail to the carrier or carriage, hardware mechanisms that are present anyway are therefore used, but are modified in their control. Existing hardware can then be used at the stator or rail side without new components possibly having to added, and changes are primarily required in the control, which can necessitate the addition of a control program.

The control of the energization of the coils of the electromagnets can take place by means of pulse width modulation (PWM). DC voltage can be switched on and off here. Or a four-quadrant controller can be used that can also reverse the energization of an electromagnet.

Pulses in the PWM are generated with a specific pulse frequency along a time grid. If, for two electromagnets that are independently controllable, separate control pulses are in each case generated, they can be generated in the same time grid, i.e. with the same pulse frequency. They can be generated for two or more different electromagnets in a settable relative phase position to one another. If the period duration corresponding to the full circle is regarded as a phase of 2π, two separate PWM signals with a fixed relative phase position can be generated for two coils to be energized if no information is to be transmitted, and with a relative phase position that varies in accordance with information to be transmitted if information is to be transmitted. The fixed relative phase position can be 0. The variable relative phase position can lie between the above-mentioned fixed relative phase position (e.g. 0) and another second phase position, e.g. not equal to 0, the latter can be greater than π/2 and can be n. In general, the second relative phase position can be shifted by at least π/4 or π/3 or π/2 or 2π/3 or 3π/4 compared to the fixed relative phase position.

If three or more coils are energized, their energization phases can be set group-wise for the information transmission by forming a group of coils of electromagnets located at the front in the direction of travel and a group of coils of electromagnets located at the rear in the direction of travel, wherein the energization phase of one group is then e.g. set in accordance with the information to be transmitted and the energization phase of the other group can be fixed or can also be selected according to certain criteria and possibly depending on transmission information.

Even with an in-phase control of all the electromagnets, flux changes in the carrier/carriage and correspondingly induced voltages can occur that do not necessarily represent an information transmission or a shifted-phase control, in particular an out-of-phase control, of coils or coil groups during the information transmission. This can be differentiated from a desired information transmission or a desired shifted-phase control, in particular an out-of-phase control, of coils or coil groups, e.g. by querying a threshold value. Only induced voltages above a voltage threshold value are evaluated as a shifted-phase control, in particular an out-of-phase control, of coils or coil groups. The voltage threshold value can be above 5 or 10 or 20 or 40% of a maximum possible threshold value. It can be less than 60 or 40 or 20 or 10% of a maximum possible voltage value. Instead or in addition, the evaluation of the induced voltages can be coupled to a start of an information transmission that has been previously recognized, for instance based on a start sequence.

The pulses primarily serve to energize the electromagnets for driving the carrier/carriage relative to the stator/rail. Due to the selectable energizable coils, a correspondingly selectable and changing magnetic field results in the carrier/carriage and is superimposed on a constant field, possibly provided by permanent magnets in the carriage, and can be detected inductively as an alternating field in the carriage. However, depending on how the relative phase position of two or more PWM signals for controlling the energization of two or more electromagnets is, different superimposed magnetic fluxes can result at the receiver side, i.e. at the side of the carrier/carriage, that can be evaluated and can serve to transmit information. In one system design, the superimposed magnetic flux resulting at the receiver side (carriage side, carrier side) can, in the case of phase alignment, essentially be 0 or small and in particular smaller than a threshold value, whereas, in another case, in particular in the case of a maximum possible phase shift of π, it can be large and in particular larger than the aforementioned or another threshold value. On the one hand, this can be used to transmit information.

However, the settable relative phase detuning can also serve for transmitting energy from the stator to the carrier by operating an inductive energy absorption at the carrier side in accordance with “power harvesting”.

More generally speaking, the control of the relative phase position of two or more PWM controls of two or more electromagnets of a linear motor stator can therefore be used for the information transmission and, if necessary, also for the energy transmission.

The coding method can be designed such that a bit-wise serial transmission takes place and that a relative phase position, e.g. 0, is set for the one of two digital values of a bit, e.g. 0, and that the other relative phase position, e.g. n, is set for the other of the two digital values of the bit, e.g. 1. To transmit a bit, the respective relative phase position can in each case keep the set value constant over one, two, three or more and preferably fewer than 20 or 15 or 10 PWM periods.

The information to be transmitted can be taken from a memory or can be generated or have been generated more or less ad hoc.

The design can be such that the second control component is activated or deactivated in accordance with the information to be transmitted. If the second control component is deactivated, it remains the sole work of the first control component to conventionally energize the electromagnets for the drive. However, if the second control component is activated, a modification can take place as described.

The control can be adapted to determine a starting point in time and/or an end point in time and/or the amount of data to be transmitted for the information transmission and to control the information transmission accordingly.

The determination of the start and the end of the energization point in time of an electromagnet can already be necessary in a conventional operation without information transmission. If many electromagnets are provided along the rail, for example with a grid of two or five centimeters, a decision must be made continuously when a carriage is moving as to which coils are currently to be energized in order to drive or brake the carriage. Not all the coils are simultaneously energized. This energization selection of electromagnets, which already results from conventional operation, can also be sufficient as a selection for the point in time of the energy transmission. However, even further criteria or other criteria can also be considered.

For example, the information transmission can be started a predetermined time period after the start of the energization of a coil for the drive. The amount of data to be transmitted can also be predetermined here. A transmission end then implicitly results from the transmission start and the transmission duration.

In the control device, the first control component can be adapted to cause the generation of first PWM control signals in a first relative phase position to one another, preferably in phase, for two electromagnets preferably spaced apart in the direction of movement, and the second control component can be adapted to cause the generation of the first PWM control signals to be converted into the generation of second PWM control signals for the two electromagnets such that said second PWM control signals are in a different second relative phase position to one another, preferably out of phase. In an operation without transmitting data, the pulse widths of the simultaneously controlled electromagnets can be different. The second control component can be adapted to match the pulse widths of the simultaneously controlled electromagnets to one another in a transmission operation. It can also be adapted to limit the pulse widths of the pulses to certain values, e.g. to a limit below 55 or 50 or 45% of the cycle time.

The first control component can be adapted to generate two or more first PWM control signals for a respective one of the two or more electromagnets spaced apart in the direction of movement in the first relative phase position, wherein the phase shift of the first relative phase position of the two first PWM control signals can be approximately 0, e.g. can be smaller in amount than π/4 or π/6, and the second control component can be adapted to generate two second PWM control signals for a respective one of the two electromagnets in the second relative phase position, wherein the phase shift of the second relative phase position of the two second PWM control signals can approximately amount to π or be greater than π/4 or π/3 or π/2 or 2π/3.

The first and second control component can be purely digital components and thus software-implementable and can provide digital output signals that can simply mean “on/off” and/or that can undergo a D/A conversion and be fed in a suitable manner to a driver circuit for the switches for energizing the electromagnets/coils.

The second control component can selectively be connectable downstream of the first control component in whole or in part and can be adapted to change an output of the first control component, preferably to cause the shifting of PWM pulses on the time axis.

In this design, the first control component operates continuously, while the second control component is selectively connected downstream in a modulating manner, or not. For example, the second control component can phase-shift the control pulses generated by the first control component by n or can cause this. If the second control component is connected downstream, it does this, whereas it does not do this if it is not connected downstream. The downstream connection can then selectively take place in accordance with the information to be transmitted, or not.

Generally speaking, in these system designs, the pulse width can therefore be generated in accordance with a drive desired value, while the relative phase position of two individual PWM signals can be settable in accordance with the information to be transmitted.

However, the second control component can also selectively be usable instead of the first control component and, in particular for PWM pulse generation, can cause the use of a second reference signal that is phase-shifted with respect to a first reference signal whose use is caused by the first control component.

In this system design, the second control component is used for at least one electromagnet instead of the first control component. For example, the second control component can use a different reference signal than the first control component to generate the pulse widths in accordance with the drive desired value. The other reference signals can then be phase-shifted. When the first control component is working, PWM pulses are generated with reference to the first reference signal, whereas, when the second control component is working, PWM pulses are generated with reference to the second reference signal and are accordingly generated phase-shifted.

The control device or the circuits and hardware can generally have one or more of the following configurations:
PWM pulse frequency above 0.5 or 1 or 2 or 5 or 10 or 20 kHz and/or below 1000 or 500 or 200 kHz or 100 kHz,
PWM as an on/off PWM or with a four-quadrant position,
maximum speed of the carrier/carriage above 1 or 2 or 5 m/s and/or below 10 or 5 or 2 m/s,
maximum speed of the fed-in traveling wave: above 20 or 50 or 100 or 200 or 500 electromagnets per second and/or below 1000 or 500 or 200 electromagnets per second,
determining the electromagnets to be energized by means of position sensors and/or by means of an interpolation and/or using an observer,
more than 5 or 10 or 20 or 30 or 50 and/or fewer than 200 or 100 or 50 separately controllable electromagnets per meter of travel.

A linear motor stator has a guide rail extending in the drive direction, a plurality of electromagnets spaced apart in the drive direction and arranged at the guide rail, switching devices for individually setting the energization of the electromagnets, and a control device as described above for controlling the switching devices.

A rail segment of a rail-supported transport system, preferably as described for the position encoder receiver, can have a linear motor stator as described.

A linear motor carrier has rollers for rolling on a guide rail extending in the drive direction, one or two or more magnets, preferably permanent magnets, an iron core connected thereto and arranged such that it can be passed through by a magnetic field generated by a linear motor stator, a pick-up coil that is wound around the iron core and that is adapted to generate induced electrical variables in accordance with a magnetic field passing through the iron core, and a circuit that is connected to the pick-up coil and that is adapted to pick up, convert and store the induced electrical variables.

The circuit can be adapted to absorb, convert and store the electrical energy inherent in the induced electrical variables. The circuit can also be adapted to detect the electrical signals that can be taken from the induced electrical variables and that bear information, to convert them, preferably into digital signals, and to store them, preferably in a digital memory.

Generally speaking, the linear motor carrier can be functionally complementary to the linear motor stator as described. One or more pick-up coils serve to pick up the magnetic flux that passes through the iron core, that, as described above, is settable at the stator side, and that can serve to transmit energy and information. In the pick-up coil, the flux causes the induction of electrical variables, in particular current and voltage, that can be picked up, converted, decoded or demodulated, if necessary, and stored. The storage can mean storing harvested energy and/or storing decoded information.

The circuit can be adapted to recognize the start of the information transmission and, from then on, to evaluate the picked-up electrical variables accordingly and to store transmitted information.

The carriage of a transport system, which can be configured as described with reference to the position encoder transmitter, can be provided with a linear motor carrier as described above for receiving information from the linear motor stator. A linear motor can have a linear motor stator as described and a linear motor carrier as described. A linear motor stator can have the features of the information transmission from the carrier to the stator and of the information transmission from the stator to the carrier. A linear motor carrier can have the features of the information transmission from the carrier to the stator and of the information transmission from the stator to the carrier.

A data carrier can have executable programs stored thereon. The programs are designed so that, when running, they implement a control device at or for the stator that is designed for the described information transmission from the stator or from the rail to the carrier or carriage.

In general form, the terms “carrier” or “carriage” are to be understood as an indication of a relative movability in relation to a stator or a rail. They can also be understood as referring to an absolute movability that is given with respect to a fixed coordinate system, such as a production hall or similar. However, the relationships can also be reversed. The carrier or carriage described can be absolutely fixed and the stator or the rail can be movable relative thereto and then also absolutely. Or the design features can be provided reversed: The carriage or carrier has two coils or electromagnets which are separately controllable in their energization and with which information can be transmitted from the carrier to the stator, while the stator has a large number of permanent magnets arranged along the direction of movement. A transmitter coil corresponding to the second magnet device can simultaneously be provided at the stator side to be able to transmit information from the stator to the carrier.

### C. GENERAL FEATURES

A position detection device can be provided for a local relative and/or global absolute position detection of a carrier/carriage relative to the stator/rail and can cooperate with the components described above and below. It can be provided such that the position of a carrier/carriage relative to the stator/rail is known at times or in places or constantly. The position can be detected by a sensor and can be interpolated if necessary. It can be known in places or constantly with a spatial resolution accuracy below a threshold value. The position detection device can be part of a carriage, carrier, stator or rail. Or a carriage, carrier, stator or rail can have an interface to such a position detection device to obtain corresponding position information.

The position detection device can comprise a plurality of position encoder receivers attached along the stator/rail, preferably as described above and below, that are adapted for the cooperation with a position encoder transmitter, preferably as described above and below, at a carrier/carriage.

The position encoder receivers can be adapted for the local, relatively spatially resolving position determination of a carriage. They can also be connected to a central control that receives signals from the connected position encoder receivers and determines the absolute position in the overall system therefrom. Not all the position encoder receivers must be adapted for receiving information to be transmitted.

A position encoder receiver can be adapted for the spatially resolving presence detection of a position encoder transmitter within the detection range. The position encoder receiver can e.g. detect and evaluate the magnetic field direction of a magnetic field from a first magnet device of a position encoder transmitter. For this purpose, the position encoder receiver can e.g. have a Hall pick-up that detects Hall voltages in mutually different and preferably mutually orthogonal directions; from this, it can detect the direction of a passing-through magnetic field; from this, the direction toward the magnet; and, from this, the position of said magnet.

Corresponding position encoder receivers can be distributed along the rail/stator such that their respective detection ranges adjoin one another and also overlap. The position of the carriage/carrier can then be completely detected by a sensor.

However, the position determination of a carrier/carriage along the stator/rail can also involve a combination of a selective detection, e.g. as described above, and therebetween a mathematical interpolation of the changing position x based on the known speed v and the elapsed time t, where x=v*t.

In this way, information can be transmitted from the carrier to the stator, and/or vice versa, depending on the system design.

### D. LIST OF FIGURES

Embodiments of the invention will be described in the following with reference to the drawings; there are shown:

FIG. 1 schematically, aspects of the invention in combination;

FIG. 2 schematically, an embodiment of a stator or a rail;

FIG. 3 schematically, an embodiment of a carrier or carriage;

FIG. 4 schematically, an embodiment of a position encoder system;

FIG. 5 schematically, the embodiment of a control of the position encoder transmitter;

FIG. 6 an embodiment of the control of the position encoder receiver;

FIG. 7 schematically, representations of the transmission scheme and of the coding at the position encoder transmitter;

FIG. 8 schematically, a system for transmitting information and energy from the stator or the rail to the carrier or carriage;

FIG. 9 schematically, the control on the part of the stator or the rail;

FIG. 10 a control scheme for stator coils;

FIG. 11 schematically, an embodiment for a coil control;

FIG. 12 schematically, the control on the part of the information receiver in the carrier/carriage;

FIG. 13 various current and voltage developments;

FIG. 14 effects caused by the coil energization;

FIG. 15 simulated current and voltage values;

FIG. 16 a known transport system; and

FIG. 17 a known electromagnetic design of a linear motor system.

### E. GENERAL FEATURES

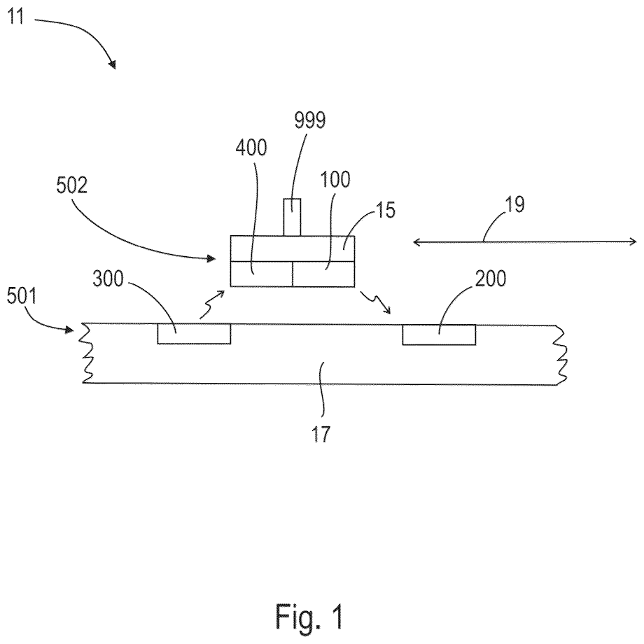

FIG. 1 schematically shows, in combination, features for the information transmission from the carriage 15 or carrier 502 to the rail 17 or stator 501 and features for the information transmission in the opposite direction. In general, it can be a multi-carrier system in which a plurality of carriers can preferably be controlled independently of one another and can be moved along a travel path. In technical terms, the carrier and the travel path can form a linear motor comprising a stator, which extends in the transport direction and is optionally closed to form a loop, and a plurality of carriers extending along the stator. More generally, it can also be a rail-bound transport system 11 comprising a rail 17, preferably closed to form a loop, and a plurality of movable carriages 15 thereat or thereon. Carriers or carriages can approach and leave the schematically shown work stations 18.

11 is generally a transport system in which 17 is an elongate rail and 15 is a carriage 15 extending along the rail. Arrow 19 indicates the direction of movement along which the carriage 15 can be moved relative to the rail 17; it is left-right in FIG. 1, in both directions. An object transported by the carriage 15 is indicated as transported goods by 999.

100 indicates a position encoder transmitter at the carriage 15 and 200 indicates a position encoder receiver at the rail 17 or the stator 501, which position encoder transmitter and position encoder receiver can be used in combination for transmitting information from the carriage 15 or the carrier 502 to the rail 17 or the stator 501. A plurality of position encoder receivers 200 can be provided along the stator 501 or the rail 17, not all of which have to be adapted to receive information.

300 indicates an information transmitter at the rail 17 or the stator 501 and 400 indicates a receiver at the carriage 15 or the carrier 502, which information transmitter and receiver can together be used for transmitting information from the rail 17 or the stator 501 to the carriage 15 or the carrier 502. A plurality of information transmitters 300 can be provided along the rail 17 or the stator 501 and each cover a certain distance.

What is not shown is a possibly present central control to which the local components, in particular a position encoder receiver 200 and an information transmitter 300, can be suitably connected, also to be able to exchange information in real time if necessary. The connection can be wired or wireless.

The central control can be adapted to receive information from a position encoder receiver 200 that can also include information about and from a carriage/carrier 15, 502. The central control can be adapted to transmit information to an information transmitter 300 that can also include information to be forwarded to a carriage/carrier 15, 502. The central control can also be adapted to select a specific one from a plurality of possible information transmitters 300 as an information receiver, for instance in accordance with position information relating to a carriage/carrier 15, 502.

The information given so far is to be understood as schematic in the sense that it is not intended to be a binding statement about the more exact distribution and number of components in the carriage/carrier or rail/stator. The features for the information transmission in the two opposite directions can be provided combined with one another or can each be provided separately from one another.

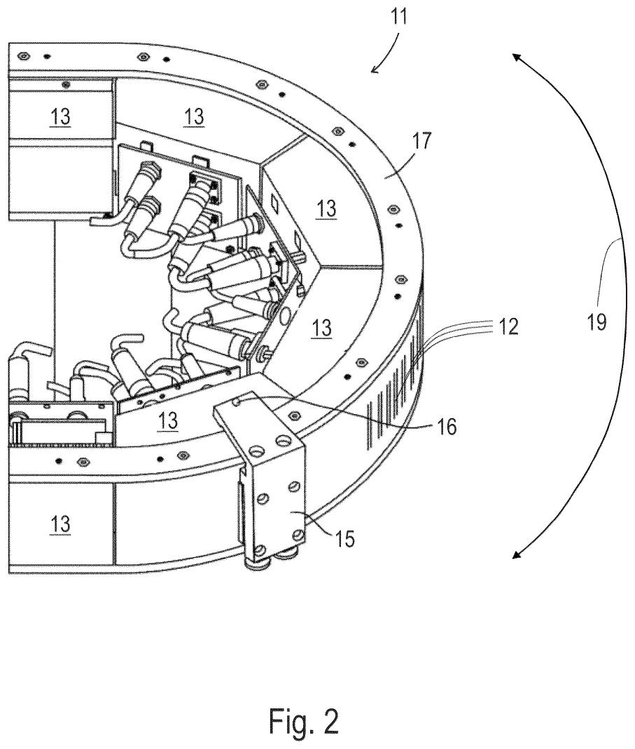

FIG. 2 is a drawing of a section of a transport system 11. 15 is a carriage that can be moved along the rail 17 drawn in a curved manner. 12 denotes many electromagnets that are attached distributed in the direction of travel. For example, more than 10 or 20 or 50 or 100 and/or fewer than 200 or 100 or 80 or 50 electromagnets can be provided per meter of the travel path, each of which can be individually controlled. Modules, which each hold a group of electromagnets together with the control, are indicated by 13. Generally speaking, the control of the many electromagnets can take place in a modular manner. The carriage 15 runs along the rail 17. It can be designed as described. The control of the coils 12 can be designed as described. 19 again indicates the direction of movement of the carriage 15 along the rail 17. 16 indicates a first magnet device 101 as a permanent magnet of a position encoder transmitter 100.

One or more position encoder receivers 200 are not shown that can be attached along the rail 17, for example regularly spaced apart, and that cooperate with the position encoder transmitter 100 or the permanent magnet 16. One or more position encoder receivers 200 are in this respect attached along the rail 17 such that the position encoder transmitter 100 passes the position encoder receiver(s) 200 at a small spacing, for example a small 5 or 2 mm, during its movement with the carriage 15 or carrier 502 so that the position encoder receiver 200 can detect and evaluate the magnetic field from the position encoder transmitter 100.

The position encoder receiver 200 can have a Hall pick-up. The Hall pick-up can be adapted to detect Hall voltages in mutually different and preferably mutually orthogonal directions and to detect, from the voltage values determined in this way, the direction of a magnetic field from a first and/or second magnet device 101, 1002 of a position encoder transmitter 100. From the direction of the magnetic field, the direction toward the magnet and, from this, the position of said magnet or the position of the carriage/carrier 15, 502 can be determined.

The spacing from or the increment between consecutive position encoder receivers 200 along the rail/stator 17, 501 can be regular and can be less than 20 or 10 or 5 or 2 cm. The detection range of a position encoder receiver 200 along the rail/stator 17, 501 can be greater than 2 or 5 or 10 cm. It can be less than 50 or 20 or 10 cm. The detection range of a position encoder receiver 200 along the rail/stator 17, 501 can be greater than 50 or 100 or 110 or 120 or 150% of the increment between consecutive position encoder receivers 200 along the rail/stator 17, 501.

A position detection device can be provided for a local relative and/or global absolute position detection of a carrier/carriage relative to the stator/rail or in the transport system and can cooperate with the position encoder transmitter 100 and the position encoder receiver 200 described above and below. The accuracy of the spatial resolution of the position detection can be less than 10 or 5 or 2 or 1 or 0.5 or 0.2 or 0.1 mm in places, in particular in the region of position encoder receivers 200 or information transmitters 300, or in the overall system.

A position detection device, in particular as described, can be part of a carriage 15 and/or a carrier 502 and/or a stator 501 and/or a rail 17 and/or a position encoder transmitter 100 and/or a position encoder receiver 200 and/or an information transmitter 300 and/or an information receiver 400. Or a carriage 15 and/or a carrier 502 and/or a stator 501 and/or a rail 17 and/or a position encoder transmitter 100 and/or a position encoder receiver 200 and/or an information transmitter 300 and/or an information receiver 400 or their control components can have an interface to such a position detection device to be able to transmit data relevant to position detection and/or to be able to receive position information. The position information that is determined or that is received via an interface can have the above-mentioned accuracy of the spatial resolution.

The thus known relative or absolute position of a carriage/carrier 15, 502 relative to the rail/stator 17, 501 or in the overall system can be used for various purposes, in particular for one or more of the following purposes:
determining the start of transmission for a position encoder transmitter 100,
determining the end of transmission for a position encoder transmitter 100,
determining the start of reception or start of decoding for a position encoder receiver 200,
determining the start of transmission for a data transmission from the rail/stator 17, 501 to the carriage/carrier 15, 502,
determining the end of transmission for a data transmission from the rail/stator 17, 501 to the carriage/carrier 15, 502,
determining the start of reception or start of decoding in a carriage/carrier 15, 502,
determining the stator coils 12 used for the data transmission,
determining the stator coils 12 used for the propulsion,
general functions.

The determinations regarding the start of transmission, start of decoding and end of transmission can be made in a stationary component, in particular in a central control, not shown, or in a position encoder receiver 200. If the determinations are required in the carriage/carrier, they can be communicated to it by a suitable mechanism. It is also possible to provide, in the carriage/carrier, a continuously running decoding of received signals that can then e.g. also search for a determined start sequence as an indication of a subsequent data transmission.

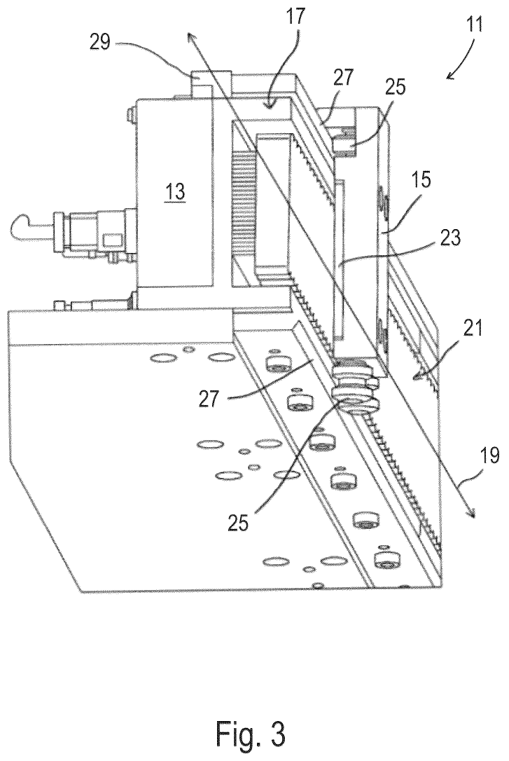

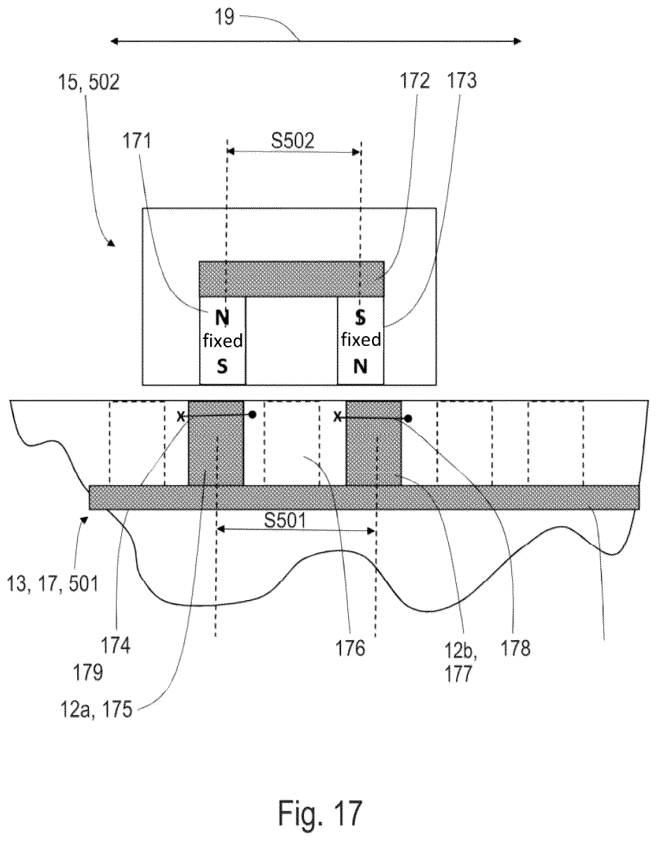

FIG. 3 shows a possible embodiment of the carriage 15 in somewhat more detail. It has powerful permanent magnets 23 as described in FIG. 17 under items 171 and 173 that pull it firmly against the rail 17 in a lateral direction. Wheels 25 then also serve for a lateral force absorption, but also hold the carriage against the force of gravity. The wheels 25 have grooves with which they run on the rail 17.

### F. COMMUNICATION FROM THE CARRIER/CARRIAGE 502/15 TO THE STATOR/RAIL 501/17

A position encoder system 100, 200 has a position encoder transmitter 100 and a position encoder receiver 200. In the embodiment shown, the position encoder transmitter 100 is connected to the carrier 502 of the linear motor or carriage 15 of the transport system and the position encoder receiver 200 is connected to the rail 17 or stator 501. However, the relationships can also be reversed.

The position encoder transmitter 100 has a conventional magnet 101, 16 that forms a first magnet device. It can be a permanent magnet. It is attached such that, when the carrier 502 is used and moved, it runs along the stator 501 or the position encoder receiver 200 at a small spacing so that stator-side or rail-side components can detect the magnetic field from the first magnet device 501.

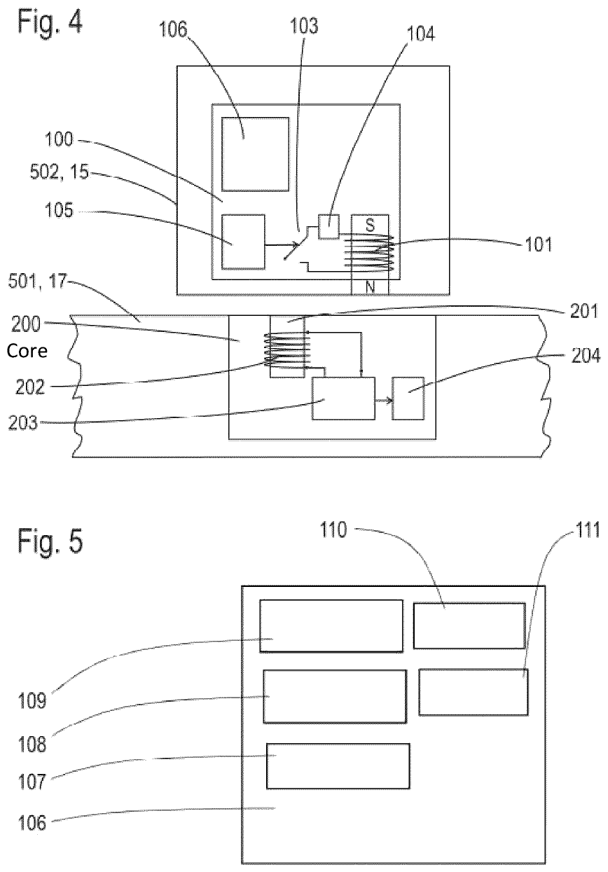

The position encoder transmitter 100 has a second magnet device 102. It is settable. It can be an electromagnet. It can be wrapped around the first magnet device 101, in particular the permanent magnet, or attached near it or in its vicinity. FIG. 4 shows an embodiment in which the setting of the second magnet device takes place by selectively switching the electromagnet on and off. However, a variable energization can also be provided that does not switch off completely. For this purpose, an energy supply 104, which can be a direct current source, such as a battery or a capacitor, is provided and a switch 103 for switching the energy supply of the electromagnet 102 on and off that then generates a sampled or variable magnetic field that can be superimposed on the magnetic field from the first magnet device 101. The permanent magnet of the first magnet device 101 can be a bar magnet whose longitudinal direction can be directed towards the receiver, for example with its south pole, or, as shown, with its north pole.

The switch 103 is actuated by a driver 105. The switch 103 can be a power semiconductor, such as an FET, MOSFET or the like. The driver circuit 105 can generate suitable control signals for this purpose. The driver circuit 105 in turn receives control signals from a control 106. The control 106 can have digital components. It can have a small computer with components such as a CPU, RAM, BUS, interface, read-only memory and the like. Analog/digital converters and digital/analog converters can be provided as required. The control 106 can be an ASIC or an FPGA.

FIG. 4 shows a stator 501 or a rail 17 in its lower part. It can extend along the direction of movement that is assumed to be left-right in FIG. 4. 200 symbolizes a locally available, stationary position encoder receiver comprising an iron core 201, an induction coil 202 or a Hall sensor, a conversion circuit 203 and an evaluation circuit 204. During operation, i.e. when the carriage 15 travels along the rail 17, the carriage 15 moves with the position encoder transmitter 100 over the position encoder receiver 200 at the rail 17. The magnet devices 101, 102 of the position encoder transmitter in this respect enter the detection range of the position encoder receiver, comprising a core 201 and an induction coil 202, for a more or less long time, also depending on the travel speed of the carriage. The position detection, on the one hand, and the data transmission or information transmission, on the other hand, can take place in this time period and adapted to this time period.

The information to be transmitted from the carriage 15 or carrier 502 to the rail 17 or stator 501 can regularly include, for example, an ID of the carriage that is preferably permanently written in it so that the receiver regularly also contains information about the individual from which the transmission is made. Unique identity data ID can be written to a memory region of the memory 110 of the control 106 of the position encoder transmitter 100. It can also include information that is written in by a previously approached station 18 and that is read out at a subsequently approached station 18.

The control 106 is shown in more detail with functional components in FIG. 5. Sources for the information or data to be transmitted can be an internal memory 110 for previously internally generated data or an interface 111 from which an encoder or a modulator 108 can extract data for transmission. The memory 110 can comprise RAM and/or ROM and/or registers, in particular a storage location for unique identity data. The data can be digitally available bit-wise. The encoder encodes the data in a suitable manner and generates signals for controlling the driver circuit 105. This can take place digitally and can undergo a subsequent digital/analog conversion.

109 symbolizes a starter or a timer for the transmission. The timer 109 determines a starting point in time for the data transmission by means of the second magnet device 102. As mentioned, the data transmission capability also depends on the position encoder transmitter 100 being in the detection range of the position encoder receiver 200. The timer circuit 109 can determine this based on certain criteria, such as an observation of the signal from the first magnet device, based on known positions, interpolation based on the travel speed and the like. It can determine a starting point in time and an end point in time for the data transmission. It can also determine a certain amount of data to be transmitted for which the available transmission time window is sufficiently long. On the other hand, the amount of data to be transmitted can also be predetermined, for instance based on system parameters that determine a minimum dwell time of a position encoder transmitter at a position encoder receiver, determinable, for instance, based on the maximum speed, the detection range, etc. The timer circuit 109 can then possibly only determine a starting point in time for the start of the data transmission.

107 is a power control circuit that controls functions of the power consumption and power storage, if necessary. It can control “power harvesting”, but is only provided if this is necessary and power for operating the control 106 and the electromagnet 102 is not available anyway.

The second magnet device 102 can be arranged such that its settable magnetic field, preferably an alternating magnetic field, is superimposed on the magnetic field from the first magnet device 101. The magnetic field change that can be set by the second magnet device 102 is dimensioned such that it can be distinguished with sufficient certainty from the DC component of the first magnet device 101. The setting can be such that, at the receiving counterpart, e.g. the core 201, the magnetic field strength from the second magnet device 102, i.e. regularly the electromagnet, is at least 2% or 5% or 10% or 20% of the amplitude of the field strength of the first magnet device. It can be limited upwards to a maximum of three times or two times or one times the amplitude of the magnetic field strength of the first magnet device.

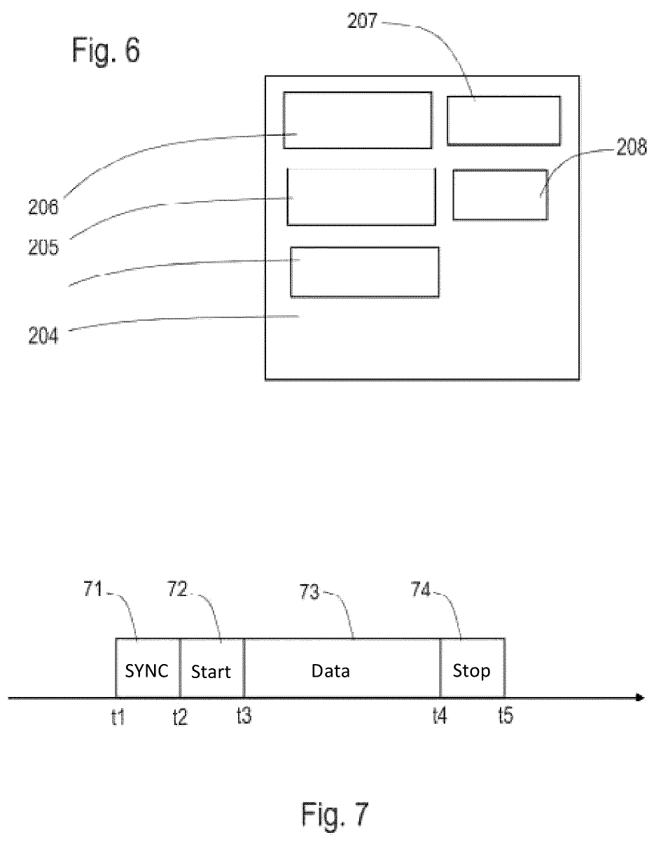

FIG. 6 schematically shows functions of the evaluation circuit 204 of the position encoder receiver 200. The conversion circuit 203 arranged upstream can, for example, perform a rectification of the inductively picked-up electrical alternating signal and can also perform a certain smoothing. The time constants can then be determined such that e.g. a smoothing takes place across half-waves, but modulations are not smoothed.

The evaluation circuit 204 can have a timer 206 that observes the signal received from the conversion circuit and evaluates it from various aspects. This can be take place in analog or—after an analog/digital conversion of the signal from the conversion circuit 203—in digital. A threshold value check can take place to determine whether the signal exceeds a threshold value that indicates the presence of a carriage in the detection range of the position encoder receiver. The signal can furthermore be examined for a DC component. The signal can also be examined for a variable component indicating a modulation. If the latter is detected, it can be decoded in a decoder or demodulator 205 that can, for example, operate inversely to the encoder or modulator 108 in the position encoder transmission circuit. A memory 208 comprising RAM and/or ROM and/or registers can be provided. An interface 208 can be provided for communication with other components.

When the decoder or demodulator 205 demodulates a modulated signal, it can write the result to an internal memory 207 and/or can output or transmit it to external via an interface 208. Like the control 106, the evaluation circuit 204 can be implemented as a small computer, ASIC, FPGA or the like. A/D and D/A converters can be provided as required.

FIG. 7 shows, by way of example, a transmission scheme set at the transmitter side that is then to be evaluated and decoded at the receiver side and that can be used for the information to be transmitted. t1 is a suitably determined starting point in time at which the transmitter starts to transmit. It can, but does not have to, first transmit a sync sequence 71 that allows the temporal synchronization of the receiver with the transmitter. At t2, a predetermined start sequence 72 can be transmitted that indicates the start of the data transmission 73 at t3. After the data transmission, a predetermined stop sequence 74 can be transmitted at t4.

At the receiver side, the sync sequence 71 can be used to set the own time base to that of the transmitter. The start sequence 72 can be demodulated/decoded and checked for correctness. The data sequence 73 can be demodulated/decoded and stored. The stop sequence 74 can be demodulated/decoded and checked for correctness.

The total transmission duration in the scheme of FIG. 7 is t5-t1. It can be fixedly predetermined and set so that it is always shorter than the shortest possible transmission window that can occur at high carriage or carrier speeds. The data transmission duration is t4-t3. It correlates with the amount of data that can be transmitted. It can also be predetermined. At the receiver side, it can also be checked whether, for example, the start sequence 72 and the stop sequence 74 are at the correct time relative to one another. The data transmission 73 can comprise repeatedly transmitting, for instance twice or three times, the same data in order, by comparing the repetitions, to be able to recognize transmission errors with probability and to correct them where possible. The transmission scheme can comprise repeatedly transmitting the information to be transmitted, e.g. twice or three times in total.

The transmitter preferably serially transmits digital information bit-wise. The coding can be a Manchester coding. The receiver works in a complementary manner to the transmitter.

The transmission starting point in time can be determined in accordance with a relative position between the transmitter and the receiver known in the system and preferably in accordance with further parameters such as a recordable field strength and/or a signal-to-noise ratio and/or speed or similar.

The relative position between the transmitter and the receiver can be determined in accordance with position sensors 16, 100, 200 and/or further information. This determination can comprise interpolating a once known position based on the relative speed and elapsed time.

The data transmission durations t4-t3 can also be settably variable, for instance in accordance with the carriage speed. It can then e.g. be communicated as part of the start sequence 72. The data rate can be greater than 100 or 200 or 500 or 1000 bps (bits per second). It can be less than 10 or 5 or 2 or 1 kbps. The reception starting point in time can be determined using a received sync sequence 71 and/or start sequence 72.

In general, a control can be present that knows certain parameters, such as static system geometry and static and dynamic system parameters, in particular dimensions of the stator 501 or the rail 17, positions of the position encoder receivers, and that accordingly determines speeds, relative positions, starting points in time 71 and, if applicable, data transmission durations t4-t3. These determinations can be made at the transmitter side or elsewhere.

The presence recognition or position measurement taking place beyond the data transmission using the magnetic field signal from the position encoder transmitter 100 or from the first magnet device 101 only indicates a priori that the first magnet device 101 is in the detection range of the position encoder receiver 200. However, the latter can, for example, have a position specification of just this receiver written in its memory 207, said position specification then being associated with the respective presence detection if this is of interest externally to the position encoder receiver. It can then be transmitted to external via the interface 208. If available, the identity specification ID of the detected carriage or carrier can also be added to such a message.

A position encoder system has the position encoder transmitter 100 as described and the position encoder receiver 200 as described. For the position encoder receiver, both the presence detection corresponding to a position detection and the data transmission can be of interest locally and can then be used and further processed locally, and/or it can be of interest externally and can then be suitably output to external via the interface 208. The position encoder system can generally be used in a linear motor comprising a stator 501 and a carrier 502 or it can generally be used in a transport system comprising a carriage 15 and possibly a rail 17. The transport system can be rail-supported or also rail-independent. Accordingly, a linear motor comprising the described position encoder system and a transport system comprising the described position encoder system are also viewed as part of the invention.

One aspect of the invention is a linear motor carrier 502 of a linear motor, comprising a position encoder transmitter 100 as claimed and/or described. A further aspect of the invention is a carriage 15 of a preferably rail-supported transport system comprising a position encoder transmitter 100 as claimed and/or described. A further aspect of the invention is a linear motor stator 501 of a rail-supported transport system 11 comprising a position encoder receiver 200 as claimed and/or described. A further aspect of the invention is a rail 13, 17 of a rail-supported transport system 11 comprising a position encoder receiver 200 as claimed and/or described. A further aspect of the invention is a position encoder system 100, 200 comprising at least one position encoder transmitter 100 as claimed and/or described and at least one position encoder receiver 200 as claimed and/or described. A further aspect of the invention is a linear motor 501, 502 comprising a stator 501 as claimed and/or described and a carrier 502 as claimed and/or described. A further aspect of the invention is a transport system 11 comprising at least one carriage 15 as claimed and/or described and a rail as claimed and/or described. A further aspect of the invention is a position encoder transmitter 100 combined with an information receiver 400 as described for receiving information. A further aspect of the invention is a position encoder system 100, 200 as claimed and/or described combined with an information transmission system 300, 400 as described for implementing, preferably for implementing an information transmission method as described for transmitting information from a stator or a rail to a carrier or a carriage.

### G. DATA TRANSMISSION FROM THE STATOR/RAIL 501/17 TO THE CARRIER/CARRIAGE 502/15

Features of the communication from the carrier or carriage to the rail or stator were described above, in particular in F. They can be combined with the following features of the communication from the stator or the rail to the carrier or carriage, but can also be used on their own.

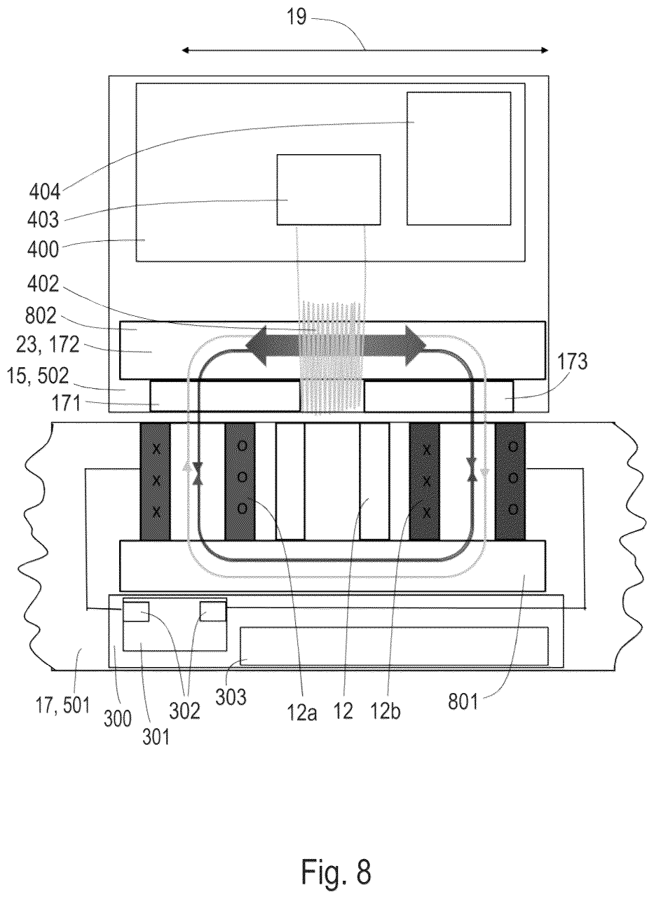

FIG. 8 shows a system for data transmission from the rail 17 or the stator 501 to the carriage 15 or the carrier 502. The carriage 15 is symbolized at the top and can move left-right according to arrow 19. A rail 17 is shown, indicated as broken off, at the bottom. The rail 17 has a sequence of electromagnets 12 which are arranged in the direction of travel 19, but of which only three are shown in FIG. 8. As already described with reference to FIG. 17, two or more of them can be energized simultaneously in conventional energization, in FIG. 8 they are the electromagnets 12a and 12b. One or more non-energized coils 12 can be located between them. The magnets 12 can sit on a common iron core 801 with their pole facing away from the carriage 15. The carriage has the permanent magnets 171, 173 and iron core 172 already described in FIG. 17. A detection coil 402 can be wound around the iron core 172 and its connections run into a conversion circuit 403. The signal of said conversion circuit 403 can in turn be further processed by an evaluation circuit 404.

Viewed clockwise from above, the magnetic circuit in FIG. 8 thus has the core 802 with a detection coil 402 thereon, a permanent magnet 173, an air gap, a coil or an electromagnet 12b, a core 801, a coil or an electromagnet 12a, an air gap and a permanent magnet 171.

In FIG. 8, it is assumed that the transmitter 300 is disposed in the rail 17 or the stator 501, while the receiver 400 is disposed in the carriage 15 or the carrier 502. It can, however, also be the other way round. The transmitter 300 has a switch block 301 for individually switching the individual electromagnets 12. For this purpose, individual switches 302 are respectively provided, of which only two are indicated. The switches can be power semiconductors as already described further above. They can receive control signals from a driver circuit, not shown. The driver circuit, in turn, can receive control signals from a control 303. A digital/analog conversion can be located at a suitable point in the signal path if it is assumed that the control 303 substantially operates digitally.

As regards the coils 12a and 12b, FIG. 8 indicates, by an entered X and O, that the coils 12a and 12b are energized in the same direction. If they are then also simultaneously energized, they generate the desired propulsive forces for driving the carriage 15 relative to the rail 17 and generate opposing fluxes in the magnetic circuit, consisting of the iron cores 801 and 172, the magnets 12a and 12b and the permanent magnets 171 and 173, that substantially cancel one another out, as indicated by the two arrows facing in opposite directions. The pick-up coil 402 is then hardly passed through by a changing magnetic flux and will accordingly generate no signal or only a small signal.

If, on the other hand, only one of the two coils 12a and 12b is energized, for example only 12b at the moment, for instance by energizing both coils 12a and 12b in an alternating manner, a flux change occurs in said magnetic circuit and is detected by the pick-up coil 402 by converting it into an induced voltage.

For the drive as a whole, it is advantageous for the reduction of losses in the iron material to energize both coils 12a and 12b virtually simultaneously. However, they can actually be energized strictly simultaneously or in an alternating manner. A strictly simultaneous energization can here also comprise the coils receiving pulses of different lengths and therefore regionally not overlapping on the time axis. If they are used strictly simultaneously, they generate mutually canceling magnetic fluxes. If, on the other hand, they are used virtually simultaneously, i.e. in an alternating manner, they each generate magnetic fluxes that can be picked up by the pick-up coil 402 as a distinctive signal. The decision as to whether coils 12a and 12b are energized strictly simultaneously or in an alternating manner can be made when transmitting data in accordance with information to be transmitted. Digital information can thus be serially transmitted bit-wise. The other energization parameters, in particular pulse widths of a pulse-width modulated energization of the coils, can be set in accordance with a drive desired value. When transmitting data, however, pulse widths can be restricted to certain limits, e.g. to a limit below 50% of the cycle time. It is then ensured that no compensating flux overlap occurs with an alternating energization.

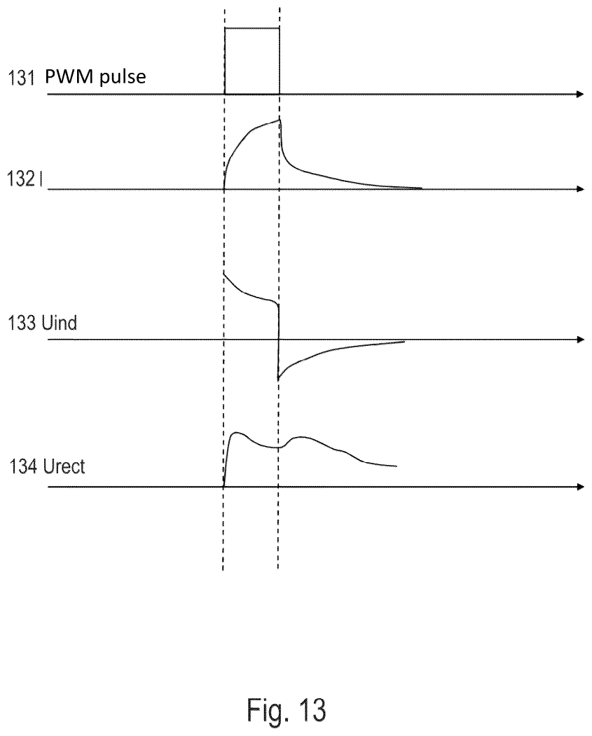

FIG. 13 generally shows some time developments. 131 is a single PWM pulse that triggers a short-term coil energization via a driver. In reality, however, PWM pulses will follow periodically. 132 shows the coil current. Since coils are inductors, the current will not follow the voltage directly as it would at an ohmic resistor, but will increase exponentially over time with a negative coefficient in accordance with the prevailing time constants and decrease over time after the switching off. 132 qualitatively shows a coil current in an electromagnet 12 of the stator 501. 133 shows an induced voltage that can be brought about in another coil by a current as shown in 132. In accordance with the law of induction, said induced voltage is proportional to dl/dt and thus has a qualitative development as shown in 133. Rectified and moderately smoothed, a development as shown in 134 can then result.

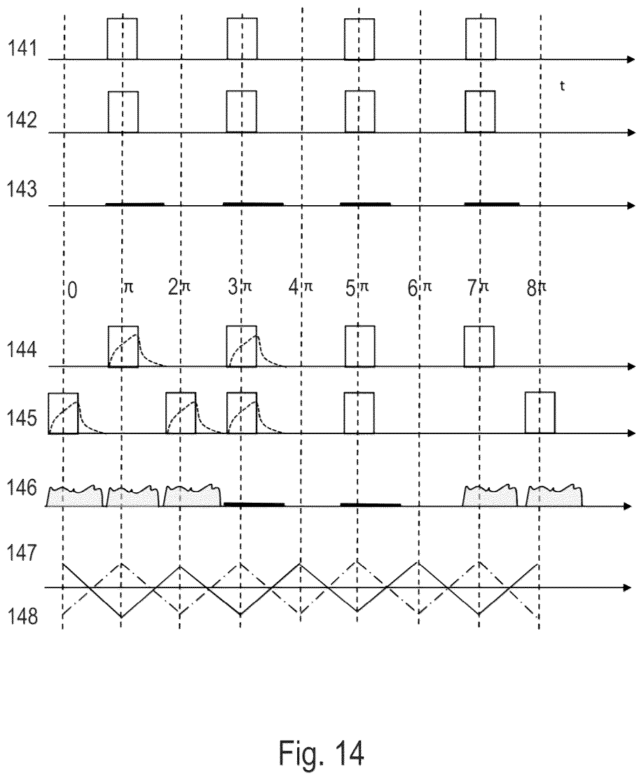

FIG. 14 shows different time diagrams. Diagrams 141 to 143 assume the case of a strictly simultaneous energization of the two coils or electromagnets 12a and 12b, while the diagrams 144 to 146 alternately show a strictly simultaneous energization and an alternating energization. In the case of a strict simultaneity of the energization of the two coils, 141 and 142 show the PWM pulses for the two coils or electromagnets 12a and 12b in the stator 501, and 143 shows the resulting induction in the carrier 502. In the case of, alternately, an alternating energization and a strictly simultaneous energization of the two coils, 144 and 145 show the PWM pulses for the two coils or electromagnets 12a and 12b in the stator 501, and 146 shows the resulting induction in the carrier 502. 144 and 145 also show exponential developments of the respective coil currents in the stator with dashed lines.

The energization of the coils can take place with pulse-width modulated pulses. These pulses are output with a pulse frequency that corresponds to a period duration. The dashed perpendicular lines in FIG. 14 each mark half-period durations, i.e., described as a phase, they are e.g. at 0, π, 2π, 3π, . . . . In FIG. 14, it is assumed that, with a strictly simultaneous energization of the coils 12a, 12b, the current pulses are each around π, 3π, 5π, 7π, . . . . A mark space ratio of approximately 25% is shown. The mark space ratio can be set in accordance with the drive desired value.

The simultaneous pulses 141 and 142 for the two coils 12a and 12b lead to substantially compensating fluxes so that, in 143, the pick-up coil 402 generates at most a small signal, which is meant to be indicated by small bars in diagram 143.

In diagrams 144 and 145, on the other hand, it is assumed that the pulses are alternately fed in up to phase 2 so that their fluxes do not compensate one another. They therefore lead to higher induced voltages in the pick-up coil 402, which is shown in diagram 146. For phase positions 3 π to 6 π, a simultaneous energization or non-energization is again assumed so that the conditions there are as shown in diagrams 141 to 143. For phase positions 7π and 8π, an alternating energization is again assumed so that relatively high induced voltages arise again as already before.

The alternating or strictly simultaneous energization of two coils or electromagnets 12a, 12b can be brought about such that the energization of a first coil takes place in a constant phase grid and the energization of the other second coil takes place in a variable phase grid. The strictly simultaneous energization can be used to transmit a digital value, e.g. “0”, of a bit sequence to be transmitted, while the alternating energization can be used to transmit the other digital value, e.g. “1”. In FIG. 14, the constant phase grid in the time diagrams 141 and 144 is shown, assumed, for instance, for a coil 12a that is energized without exception at the periods π, 3π, 5π, 7π, generally π+2nπ. A switchover can be provided for the other second one of the two electromagnet coils, for example 12b in FIG. 8. Diagram 142 shows the energization of the second coil without switching over, while diagram 145 shows the energization of the second coil with a switching over of the phase position.

With a strictly simultaneous energization, the energization of the second coil takes place at the same phase position as the energization of first coil 12a, shown at phase positions 3 π and 5 π. With an alternating energization of the second coil, on the other hand, a switchover is made to a different phase position, shown in diagram 145 at phase positions 0, 2π and 8π. Technically, this can be achieved, for example, by controlling the energization of the one coil exclusively in accordance with a reference signal, for example 147 in FIG. 14, while the energization of the other coil selectively takes place in accordance with the one reference signal 147 or a second reference signal 148 phase-shifted in relation thereto. The reference signals 147, 148 can actually be generated or can be generated as a computational image.

A transmission scheme set at the transmitter side can be designed as described for FIG. 7. The receiver accordingly works in a complementary manner. The other features discussed with respect to FIG. 7 can also be implemented at the transmitter and/or receiver side.

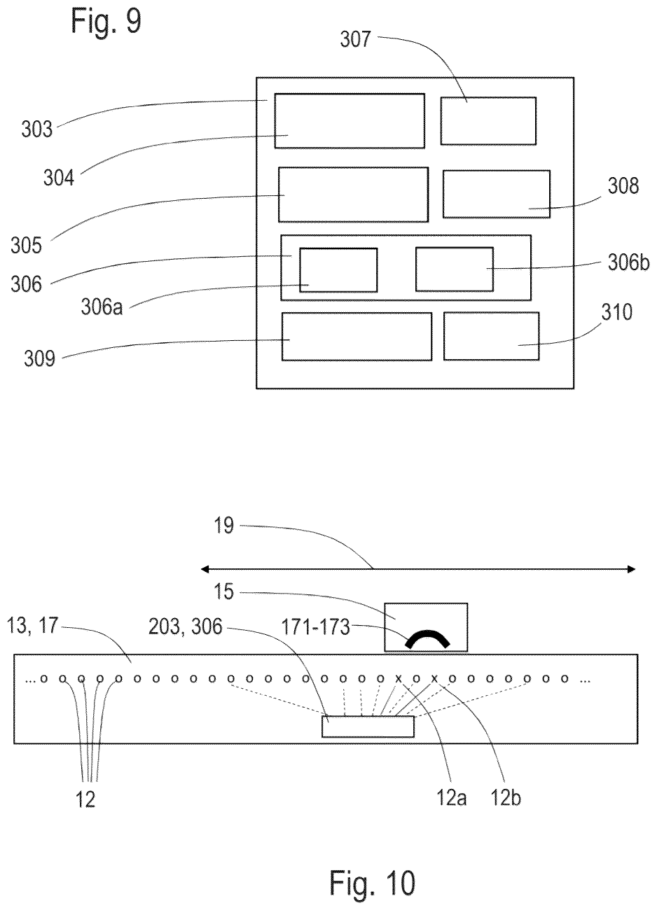

FIG. 9 schematically shows the control 303 with function blocks therein. It can have an encoder or a modulator 305 that receives information to be transmitted, for instance from a memory 307 or from an interface 310, and encodes it in a suitable manner or uses it for modulation. The memory 307 can comprise RAM and/or ROM and/or registers. 306 is a PWM circuit that converts the results of the coding circuit 305 into PWM signals for controlling the electromagnets of the stator 501 or the rail 17. The pulse widths are in this respect set in accordance with a drive desired value from a drive control 308.

The PWM circuit 306 has a first control component 306a and a second control component 306b. The first control component 306a can initiate the strictly simultaneous energization of the two electromagnets 12a, 12b, while the second control component 306b can initiate the alternating energization of the two electromagnets 12a, 12b. The use of the two control components 306a and 306b is controlled in accordance with the information to be transmitted, i.e. in accordance with the output of the encoder 305.

309 is a coil selection circuit that selects, in a conventional manner, the coils currently to be energized. FIG. 10 shows more detailed information in this regard. The rail 17 and the carriage 15, which can be moved along the rail 17 in the left-right direction according to arrow 19, are again shown schematically. In the rail 17, many electromagnets preferably of the same design, which can selectively be energized or not, are shown by o and x. Only those in the vicinity of the carriage 15 are energized in each case so that a selection must be made using the selection circuit 309.

In FIG. 10, two coils 12a and 12b that have just been selected are marked with an x, while the other coils, which are otherwise of the same design, are marked with an o. All are selectable, but only some, preferably two, are specifically selected. The selection changes according to the travel of the carriage 15 on the rail 17 and, accordingly, there are dwell times during which the carriage 15 is in the range of a currently selected pair of electromagnets.

304 in FIG. 9 is a possibly necessary timer that sets a starting point in time for transmitting information and possibly also an end point in time for this purpose and/or an amount of data to be transmitted. This can be done in the same way as described above for FIG. 7. If the data transmission cannot be continued by changing the selection of electromagnets 12 to be energized, a starting point in time and, if necessary, an end point in time for the data transmission must be determined. The data transmission can then take place within the set time period using a fixed pair of electromagnets. Other electromagnets can thereafter be selected and data can be transmitted again, if necessary.

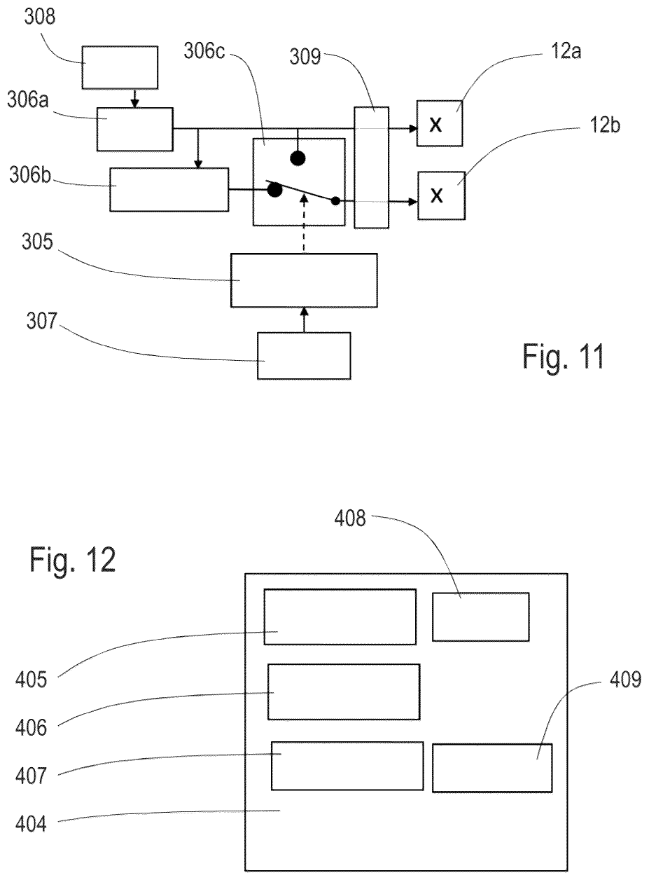

FIG. 11 shows a possibility of the coil control. The first control component 306a generates, in a conventional manner, a pulse width modulation signal in accordance with a drive desired value from a drive control 308. In any case, this signal can be used to control a coil 12a. The second control component 306b performs a phase shift, for example by π, for the signal generated by the first control component. A selector switch 306c is symbolized for energizing the second coil 12b and is actuated in accordance with the possibly necessary coding. The signal originating from the first control component 306a or the signal originating from the second control component 306b can selectively be chosen to energize the second coil 12b. To encode a character or a character string, the switchover can take place multiple times. When both coils 12a and 12b are energized with the signal from the first control component 306a, they are energized strictly simultaneously, whereas, when they are energized with the phase-shifted signals, they are accordingly energized out of phase. The coil selection circuit for the coils to be energized is again symbolized by 309.

Unlike shown in FIG. 11, the coils 12a and 12b can, however, also be controlled with pulses generated largely independently of one another, apart from the phase position. They can have different pulse widths from one another. This can also be the case during the data transmission. Even in the case of an in-phase control, an alternating flux then results in the carriage if the longer of the two pulses exceeds the shorter one on the time axis. After a suitable smoothing, this can, however, be distinguished from the out-of-phase control by means of a threshold value decision.

What has already been stated above regarding position sensors and, if necessary, interpolation can apply to the determination of the start of transmission and/or the end of transmission and/or the start of decoding.

FIG. 12 shows the evaluation circuit 404 in the receiver 400 in the carrier 502 or the carriage 15. The conversion circuit 403 arranged upstream can, for example, perform a rectification and a moderate smoothing of the received alternating signal to smooth the half-waves, for example. However, the smoothing may not smooth away modulation results.

The evaluation circuit 404 receives the signal from the conversion circuit and processes it further. It can have an observer 405 that determines whether modulated or valid signals are present, or not. Known wireless data transmission technologies can be used here. A method in which an ongoing demodulation takes place is conceivable. Using mathematical procedures such as cyclic redundancy checks (CRC), it can then be checked whether valid data are present. The method can be applied such that random noise never leads or is very unlikely to lead to valid data.

The observer can include a threshold decision maker. Exceeding a threshold value can be understood as the start of a modulation and, if necessary, a decoder or demodulator 406 can then be enabled to which the signals from the conversion circuit 403 are fed. Here, too, an analog/digital conversion can, if necessary, be provided at a suitable point, at least where signal processing is involved. The decoder 406 can operate inversely to the encoder 305 and generate a decoded character or bit sequence that can, for example, be stored in a memory 408 or can be output to external via an interface 409. The memory 408 can comprise RAM and/or ROM and/or registers. 407 can be a power control circuit that controls any necessary functionalities such as power consumption, e.g. “power harvesting”.

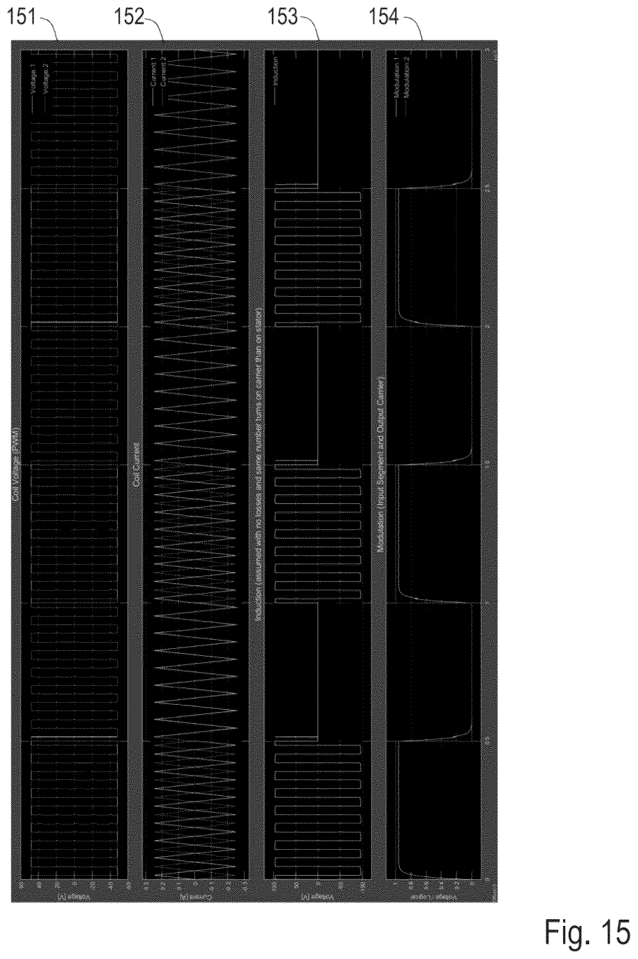

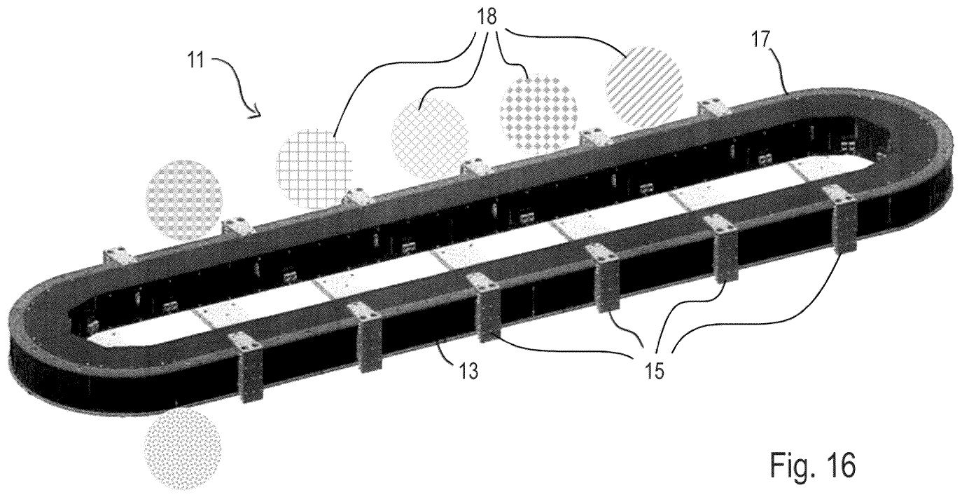

FIG. 15 shows simulated wave shapes. 151 shows, in a superimposed manner, PWM pulses for two electromagnets, at times in phase and at times out of phase. A mark space ratio of approximately 50% in a four-quadrant controller is assumed. If they are in phase, the PWM pulses lie on top of one another; if they are out of phase, they fill the diagram completely with an assumed mark space ratio of 50%.

152 shows the coil currents. They appear triangular in shape, corresponding to the gradually increasing development of the current in the case of a voltage jump at an inductor. Here, too, they lie on top of one another in the case of an in-phase control of two coils, whereas they are out of phase in the case of an out-of-phase or alternating control.

153 shows the induced voltage resulting at the detection coil 402 in the carriage 15. In the case of an out-of-phase or alternating control, it is strikingly present since the fluxes that are not simultaneously generated do not compensate one another, as explained further above, whereas, in the case of an in-phase control of the two coils, it is approximately 0 since the simultaneously generated fluxes compensate one another. The shown blocks of eight PWM cycles each can, for example, be understood as one data bit each. 153 would therefore show a 010101 sequence. One bit duration is then that of eight PWM cycles; the bit rate is correspondingly one eighth of the PWM pulse frequency.

154 shows a rectified and smoothed signal from the pick-up coil 402. On the one hand, it can be understood as a data signal and can thus be fed to the decoder. On the other hand, it can also be understood as a power input and used for energy generation in the sense of “power harvesting”.

The decoder in the carriage/carrier can generate digital values corresponding to a bit sequence from the received analog raw signal. It can have a rectifier and possibly a low-pass filter whose time constant can be longer than the desired bit duration. It can also have an interface to digital components, for instance to a digital memory to which the digital bits are written serially.

The invention can also be regarded as an information sending method or an information receiving method in transport system components—rail 17 and carriage 15—or in linear motor components—stator 501 and carrier 502—and as an information transmission method in a linear motor or a transport system. These methods preferably take place in the above-described components.

The information sending method takes place in a linear motor component or transport system components comprising at least two independently controllable coils or electromagnets for the drive. One PWM control signal each is generated for each of the two coils. The pulse widths of the control signals are set in accordance with a drive desired value. The relative phase position of the PWM control signals is set in accordance with the information to be transmitted.

This setting can comprise changing the setting of the relative phase position of the PWM control signals multiple times, in particular switching between two different phase positions multiple times, in particular in accordance with a bit sequence of digital information to be transmitted serially.

The information receiving method takes place in a linear motor component or transport system components comprising passive magnetic components. A changing magnetic flux generated in a passive magnetic component, in particular an iron core or a permanent magnet, is converted into electrical variables. They are subjected to a signal evaluation and in particular a decoding or demodulation. The changing magnetic flux is preferably generated using the above-described information sending method.

An information transmission method has the above-described information sending method and the above-described information receiving method.

Feature combinations (MK) relating to the data transmission or the communication from the stator/rail 501/17 to the carrier/carriage 502/15 can be:
MK 1. A control device (303) for controlling the feeding of electrical power to electromagnets (12) of an electric drive, in particular a linear motor stator (300), having a control device comprising
a first control component (306a) that is adapted to cause, in accordance with a drive desired value, the generation of first PWM control signals for controlling the energization of the electromagnets, and
a second control component (306b) that is adapted to cause, in accordance with information to be transmitted, the generation of the first PWM control signals to be converted into a generation of other second PWM control signals.
MK 2. A control device (303) according to MK 1, in which
the first control component is adapted to cause the generation of first PWM control signals in a first relative phase position to one another, preferably in phase, for two or more electromagnets (12a, 12b) preferably spaced apart in the direction of movement,
and the second control component is adapted to cause the generation of the first PWM control signals to be converted into the generation of second PWM control signals for the two electromagnets such that said second PWM control signals are in a different second relative phase position to one another, preferably out of phase.
MK 3. A control device (303) according to MK 2, in which
the first control component is adapted to generate two first PWM control signals for a respective one of the two electromagnets in the first relative phase position, wherein the phase shift of the first relative phase position of the two first PWM control signals can be 0, and
the second control component is adapted to generate two second PWM control signals for a respective one of the two electromagnets in the second relative phase position, wherein the phase shift of the second relative phase position of the two second PWM control signals can be n.
MK 4. A control device (303) according to MK 2 or MK 3 that is adapted for a bitwise serial transmission of digital data, wherein a first relative phase position is set for the one of two digital values of a bit and the second relative phase position is set for the other of the two digital values of the bit.
MK 5. A control device (303) according to MK 2 or MK 3, in which the control device is adapted to activate and deactivate the second control component in accordance with the information to be transmitted.
MK 6. A control device (303) according to any one of MKs 1 to 5, in which the control is adapted to determine a starting point in time and/or an end point in time and/or the amount of data to be transmitted for the information transmission and to control the information transmission accordingly.
MK 7. A control device (303) according to any one of MKs 1 to 6, in which the second control component (306b) can selectively be connected downstream of the first control component and can in particular be adapted to change an output of the first control component (306a), preferably to cause the shifting of PWM pulses on the time axis.
MK 8. A control device (303) according to any one of MKs 1 to 6, in which the second control component (306b) can selectively be used instead of the first control component (306a) and, in particular for PWM pulse generation, causes the use of a second reference signal (148) that is phase-shifted with respect to a first reference signal (147) whose use is caused by the first control component (306a).
MK 9. A control device (303) according to any one of MKs 1 to 8 comprising one or more of the following configurations
   PWM pulse frequency above 1 or 2 or 5 or 10 or 20 kHz and/or below 1000 or 500 or 200 or 100 or 50 or 20 kHz,
   max. speed of the fed-in traveling wave above 20 or 50 or 100 electromagnets per second and/or below 1000 or 500 or 200 electromagnets per second,
   determining the electromagnets to be energized and/or the start of transmission by means of position sensors and/or by means of a position interpolation and/or a position observer.
MK 10. A linear motor stator (300) comprising
a guide rail (17) extending in the drive direction (19),
a plurality of electromagnets (12) spaced apart in the drive direction and arranged at the guide rail,
switching devices (302) for individually setting the energization of the electromagnets, a control device (303) according to any one of MKs 1 to 9 for controlling the switching devices.
MK 11. A rail (13, 17) of a rail-supported transport system (11) comprising a linear motor stator (300) according to MK 10.
MK 12. A linear motor carrier (500) comprising
rollers (25) for rolling on a guide rail (17) extending in the drive direction (19), a magnetic core (23, 401) that is arranged such that it can be passed through by a magnetic field generated by a linear motor stator (300),
a pick-up coil (402) that is wound around the magnetic core and that is adapted to generate induced electrical variables in accordance with a magnetic field passing through the magnetic core,
a circuit (400) that is connected to the pick-up coil and that is adapted to pick up, convert and store the induced electrical variables.
MK 13. A linear motor carrier (15, 400) according to MK 12, in which the circuit is adapted to absorb, convert and store the electrical energy inherent in the induced electrical variables.
MK 14. A linear motor carrier (15, 400) according to MK 12 or 13, in which the circuit is adapted to pick up, convert, preferably into digital signals, and store, preferably in a digital memory, the electrical signals that can be taken from the induced electrical variables, wherein the circuit can have an evaluation circuit (404) for decoding and/or demodulating a signal received from the pick-up coil (402).
MK 15. A linear motor carrier (15, 400) according to any one of MKs 12 to 14, in which the circuit is adapted to recognize the start of the information transmission and, from then on, to store the picked-up electrical variables as transmitted information.
MK 16. A carriage (15) of a transport system (11), preferably according to MK 11, comprising a linear motor carrier (15, 400) according to any one of MKs 12 to 15.
MK 17. A linear motor comprising
a linear motor stator according to MK 10, and
a linear motor carrier (400) according to any one of MKs 12 to 15.
MK 18. A transport system comprising a linear motor according to MK 17.
MK 19. An information sending method in a linear motor component comprising at least two independently controllable coils or electromagnets for the drive in which one PWM control signal each is generated for each of the two coils, wherein the pulse widths of the control signals are set in accordance with a drive desired value and the relative phase position of the PWM control signals is set in accordance with the information to be transmitted, wherein the setting can comprise changing the setting of the relative phase position of the PWM control signals multiple times, in particular switching between two different phase positions multiple times, in particular in accordance with the respective bits of a bit sequence of digital information to be transmitted serially.
MK 20. An information receiving method in a linear motor component comprising passive magnetic components, in which a changing magnetic flux generated in a passive magnetic component is converted into electrical variables that are subjected to a signal evaluation and in particular to a decoding or demodulation, wherein the changing magnetic flux is preferably generated using the information sending method according to MK 19.
MK 21. An information transmission method comprising the information sending method according to MK 19 and the information receiving method according to MK 20.
MK 22. A linear motor stator comprising
a control according to any one of MKs 1 to 9; and
a position encoder receiver according to one of the MKs 10 to 11.
MK 23. A linear motor carrier comprising
a linear motor carrier according to any one of MKs 12 to 15; and
a position encoder transmitter according to any one of the MKs 1 to 9.
MK 24. A linear motor comprising
a linear motor carrier according to MK 23; and
a linear motor stator according to MK 22.
MK 25. A transport system rail comprising
a linear motor stator according to MK 10; and
a position encoder receiver according to one of the MKs 10 to 11.
MK 26. A transport system carriage comprising
a linear motor carrier according to any one of MKs 12 to 15; and
a position encoder transmitter according to any one of the MKs 1 to 9.
MK 27. A transport system comprising
a transport system rail according to MK 25; and
a transport system carriage according to MK 26.
MK 28. A data carrier with one or more executable programs stored thereon, which executable program or programs, when executed, implement a control device (303) according to MK 1 to 9 and/or an evaluation circuit (404) of a linear motor carrier (15, 400) according to MK 14.

### H. COMMUNICATION IN BOTH DIRECTIONS

Up to now, the communications in both directions have been described separately. However, they can also be provided combined, as already indicated in FIG. 1. The carriage 15 or the carrier 502 has the position encoder transmitter 100 and the receiver 400. The rail 17 or the stator 501 has the position encoder receiver 200 and the transmitter 300.

If the position encoder transmitter 100 and receiver 400 at the carriage 15 or carrier 502 require the same components, they can be used together, for instance an energy supply, digital hardware and computing power, memory, A/D conversion, D/A conversion, interfaces and the like. The same applies analogously to the position encoder receiver 200 and transmitter 300 at the rail 17 or stator 501. At the stator/rail side, local components can be the destination or source of the information to be transmitted or can serve for forwarding to or from a central control.

### I. GENERAL FEATURES

A data carrier with one or more executable programs stored thereon is also specified, which executable program or programs, when executed in a digital device, implement, together with said digital device, a setting device 103-106 of a position encoder transmitter 100 and/or an evaluation device 203 of a position encoder receiver 200 and/or a control device 303 for a linear motor stator 300 and/or an evaluation circuit 404 of a linear motor carrier 15, 400, insofar as they or their components are software-implementable.

The features described in this description and the claims or shown in an illustration should apply as combinable with one another even if their combination is not explicitly described, provided that the combination is technically possible. Features described in a specific context, in a specific embodiment, Figure or in a specific claim should also be considered as separable from this claim, context, embodiment or Figure and combinable with any other Figure, claim, embodiment or context if this is technically possible. Embodiments and Figures should not be understood as necessarily exclusive with respect to one another. Descriptions of a method or a sequence or a method step or a sequence step are also to be understood as descriptions of devices and/or possibly program instructions of an executable code on a data carrier that are suitable for implementing the method or the sequence or the method step or the sequence step, and vice versa.

1. A position encoder transmitter comprising
a first magnet device,
a settable second magnet device that is fastened to or near the first magnet device and that can be an electromagnet, and
a setting device for the second magnet device that is adapted to cause or perform the setting of the second magnet device in accordance with information to be transmitted and that can have a current control for the electromagnet.

2. The position encoder transmitter according to claim 1, in which the first magnet device is a permanent magnet.

3. The position encoder transmitter according to claim 1, in which the first magnet device is a permanent magnet and the second magnet device is an electromagnet whose coil is wound around the permanent magnet,
wherein the electromagnet and the current control can be adapted to generate a magnetic field of a field strength whose amplitude at an associated magnetic field pick-up is at least 1% or 5% or 10% or 20% of the amplitude of the field strength of the first magnet device at the associated pick-up and/or whose amplitude is at most 5 times or 2 times or 1 times the amplitude of the field strength of the first magnet device.

4. The position encoder transmitter according to claim 1, comprising an inductively energy-absorbing energy supply.

5. The position encoder transmitter according to claim 1, comprising
an information generating device for providing information to be transmitted, and
a coding device that is adapted to generate signals for the setting device in accordance with the information provided.

6. The position encoder transmitter according to claim 5, wherein the information generating device is a digital information generating device.

7. The position encoder transmitter according to claim 1, comprising
a support to which the first magnet device and the second magnet device are fastened, wherein the support can be fastened to a linear motor carrier or a carriage of a transport system.

8. The position encoder transmitter according to claim 1, in which the first magnet device and the second magnet device have an electromagnet, wherein the setting device is adapted to set the second magnet device differently when transmitting the information to be transmitted than without the transmission of information.

9. The position encoder transmitter according to claim 8, in which the first magnet device and the second magnet device have the same electromagnet.

10. The position encoder transmitter according to claim 8, wherein the setting device is adapted to set the second magnet device differently when transmitting the information to be transmitted than without the transmission of information such that no field is set or a constant field is set without the transmission of information and a field that changes in accordance with the information to be transmitted is set when transmitting information.

11. The position encoder transmitter according to claim 1, in which the control has a timer that is adapted to determine a starting point in time and/or an end point in time and/or the amount of data to be transmitted for the information transmission and to control the information transmission accordingly.

12. The position encoder transmitter according to claim 1, in which the second magnet device is an electromagnet and the setting device has a switching device that is adapted to switch the electromagnet on and off in accordance with digital information to be transmitted.

13. The position encoder transmitter according to claim 12, in which the switching device comprises one or more semiconductor power switches.

14. The position encoder transmitter according to claim 1, comprising one or more of the following designs:
modulation method: amplitude modulation of an alternating field, Manchester code
switching frequency of the setting device greater than 100 or 200 or 500 Hz and/or less than 20 or 10 or 5 or 2 kHz.

15. A position encoder receiver comprising
a pick-up operating inductively or using the Hall effect that is adapted to convert an external magnetic field into electrical signals, and
an evaluation device that is adapted to convert the electrical signals and to extract, from them, a first piece of position information and a transmitted second piece of information as digitally processable information.

16. The position encoder receiver according to claim 15 wherein the external magnetic field is an external magnetic field of a position encoder transmitter, the position encoder transmitter comprising a first magnet device,
a settable second magnet device that is fastened to or near the first magnet device and that can be an electromagnet, and
a setting device for the second magnet device that is adapted to cause or perform the setting of the second magnet device in accordance with information to be transmitted and that can have a current control for the electromagnet.

17. A position encoder receiver according to claim 15, in which the evaluation device is adapted to recognize signals from an external permanent magnetic field and, accordingly, to generate a first piece of digitally processable information as position information, and to recognize signals from an external alternating magnetic field and, accordingly, to generate a second piece of digitally processable information in a manner corresponding to a second piece of information transmitted with the alternating magnetic field.

18. The position encoder transmitter according to claim 1, having a position detection device for determining the position of a carriage or a carrier or having an interface to such a position detection device for receiving corresponding position information, wherein the device is adapted to use the position information determined by the position detection device or received from the interface for one or more of the following purposes:
determining the start of transmission for a position encoder transmitter (100),
determining the end of transmission for a position encoder transmitter (100),
determining the start of reception or start of decoding for a position encoder receiver,
general functions.

19. The position encoder receiver according to claim 15, having a position detection device for determining the position of a carriage or a carrier or having an interface to such a position detection device for receiving corresponding position information, wherein the device is adapted to use the position information determined by the position detection device or received from the interface for one or more of the following purposes:
determining the start of transmission for a position encoder transmitter (100),
determining the end of transmission for a position encoder transmitter (100),
determining the start of reception or start of decoding for a position encoder receiver,
general functions.

20. A position encoder system comprising at least one position encoder transmitter comprising
a first magnet device,
a settable second magnet device that is fastened to or near the first magnet device and that can be an electromagnet, and
a setting device for the second magnet device that is adapted to cause or perform the setting of the second magnet device in accordance with information to be transmitted and that can have a current control for the electromagnet
and at least one position encoder receiver comprising
a pick-up operating inductively or using the Hall effect that is adapted to convert an external magnetic field into electrical signals, and
an evaluation device that is adapted to convert the electrical signals and to extract, from them, a first piece of position information and a transmitted second piece of information as digitally processable information.

21. The position encoder system according to claim 20, combined with an information transmission system for implementing an information transmission method for transmitting information from a stator or a rail to a carrier or a carriage.

22. A data carrier with one or more executable programs stored thereon, which executable program or programs, when executed, implement a setting device of a position encoder transmitter comprising
a first magnet device,
a settable second magnet device that is fastened to or near the first magnet device and that can be an electromagnet, and
a setting device for the second magnet device that is adapted to cause or perform the setting of the second magnet device in accordance with information to be transmitted and that can have a current control for the electromagnet; and/or an evaluation device of a position encoder receiver comprising
a pick-up operating inductively or using the Hall effect that is adapted to convert an external magnetic field into electrical signals, and
an evaluation device that is adapted to convert the electrical signals and to extract, from them, a first piece of position information and a transmitted second piece of information as digitally processable information.
